(19) United States
(12) Patent Application Publication
(10) Pub. No.: US 2003/0150417 A1
(43) Pub. Date: Aug. 14, 2003

(54) Automatic engine start and stop system for vehicles

(75) Inventor: Makoto Miwa, Kariya-City (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION

(21) Appl. No.: 10/356,553

(22) Filed: Feb. 3, 2003

(30) Foreign Application Priority Data
Feb. 12, 2002 (JP) 2002-33726

(51) Int. Cl. F02N 17/00

(52) U.S. Cl. 123/179.4

(57) ABSTRACT

An automatic engine start and stop system for vehicles automatically stops and then starts an engine of a vehicle when predetermined automatic stop condition and start condition are satisfied, respectively. The system determines whether a fuel tank is being refueled after the engine is automatically stopped. If the refueling is detected, the engine is prohibited from being automatically started even if the predetermined automatic start condition is satisfied.

### CROSS REFERENCE TO RELATED APPLICATION

This application is based on and incorporates herein by reference Japanese Patent Application No. 2002-33726 filed on Feb. 12, 2002.

### FIELD OF THE INVENTION

The present invention relates to an automatic engine start and stop system for vehicles, which automatically stops and then starts a vehicle engine at traffic lights under respective predetermined conditions.

### BACKGROUND OF THE INVENTION

An automatic engine start and stop system is proposed, for instance in U.S. Pat. No. 3,731,108 or JP-A-6-257482, to automatically stop and start a vehicle engine at traffic lights, etc. to save fuel and improve exhaust emissions. JP-A-6-257482 further proposes to automatically start an engine when an electric load is turned on under the engine is at rest, so that a battery for powering the electric load is charged. In this system, if an electric load is turned on while refueling at a gas station with the engine being at rest, the engine is unexpectedly and unnecessarily started.

### SUMMARY OF THE INVENTION

It is therefore an object of the present invention to provide an automatic engine stop and start system for vehicles to limit an automatic engine start at the time of refueling.

According to the present invention, a refueling operation is detected in response to opening/closing of a fuel tank inlet, fuel level changes in a fuel tank, pressure changes in the fuel tank or in evaporated fuel gas purge system, or the like. An automatic engine starting is prohibited when the refueling operation is detected.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an automatic engine start and stop system for vehicles according to an embodiment of the present invention;

FIG. 2 is a flow diagram showing control processing executed in the embodiment;

FIG. 3 is a diagram showing a logic condition for an automatic engine stop operation in the embodiment;

FIG. 4 is a diagram showing a logic condition for an automatic engine start operation in the embodiment; and

FIG. 5 is a diagram showing an operation of the embodiment.

### DETAILED DESCRIPTION OF THE PREFERRED EMBODIMENT

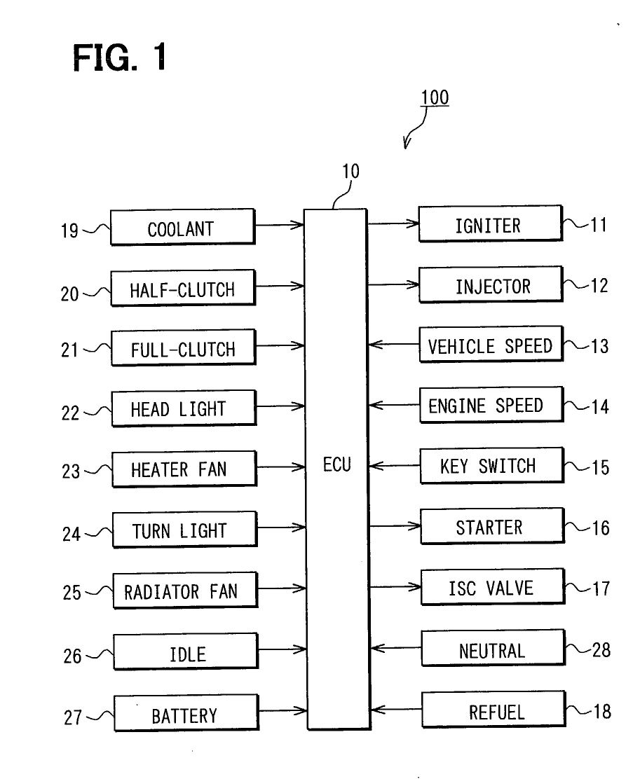

Referring to FIG. 1, an automatic engine start and stop system 100 has an electronic control unit (ECU) 10 that is constructed of a CPU, ROM, RAM, backup RAM and other circuits.

The ECU 10 is connected to an igniter 11 that controls ignition sparks generated by a spark plug mounted in each combustion chamber of an internal combustion engine. The ECU 10 is connected to an injector 12 that supplies fuel into the combustion chamber.

The ECU 10 is further connected to an engine key switch (ignition switch) 15, a starter 16 and an idle speed control (ISC) valve 17. The key switch 15 is operable manually by a vehicle driver to start and stop the engine. The starter 16 is driven to start the engine when the key switch 15 is turned on manually or when a predetermined automatic engine start condition is satisfied. The ISC valve 17 is provided to bypass the throttle valve and driven to regulate the amount of intake air of the engine for controlling the idle speed of the engine.

The ECU 10 is connected to various sensors and switches that detect operating conditions of the engine or vehicle. A vehicle speed sensor 13 detects a travel speed of the vehicle, and an engine speed sensor 14 detects a rotation speed of an engine crankshaft. A refuel switch 18 is attached to a fuel tank inlet to detect refueling. A coolant temperature sensor 19 detects coolant temperature of the engine. A half-clutch sensor 19 detects a clutch operation start indicated by a half or light pressing of a clutch by a driver, and a full-clutch sensor 20 detects a clutch operation end indicated by a full pressing of the clutch. A headlight switch 22, heater fan switch 23, turn signal switch 24 and radiator fan switch 25 detect ON/OFF conditions of headlights, heater fan of an air-conditioner, turn signal lights and radiator fan of the vehicle, respectively. An idle switch 26 detects an idling condition of the engine. A battery sensor 27 detects a battery voltage. A neutral switch 28 detects a neutral position of a manual transmission.

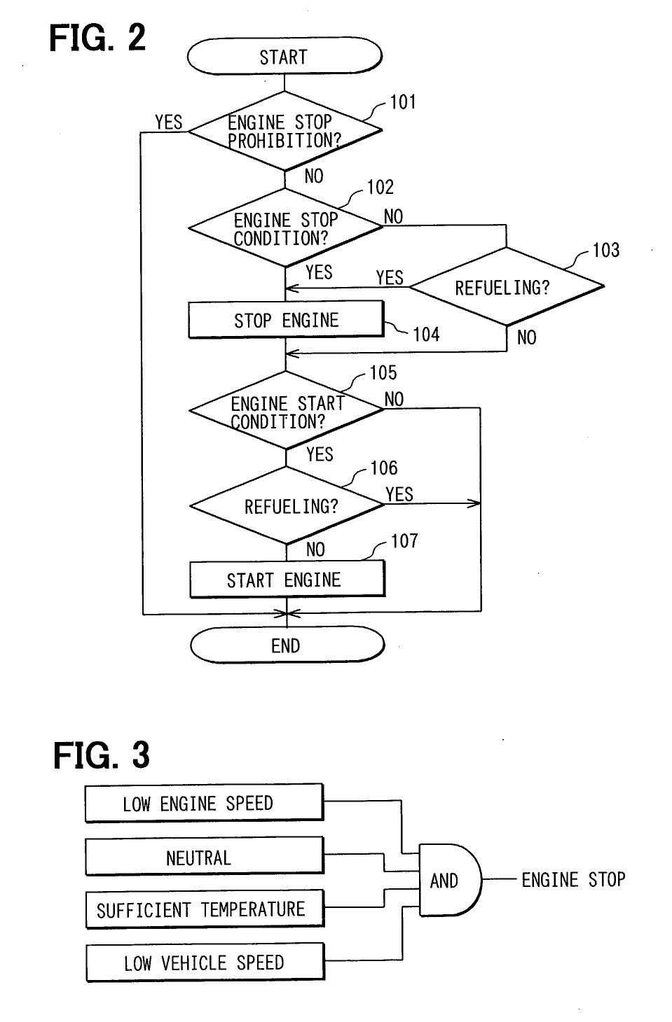

The ECU 10 calculates the appropriate amounts of control of the igniter 11, injector 12, starter 16 and ISC valve 17 in response to the operating conditions detected by the sensors and switches, and controls the igniter 11, injector 12, starter 16 and ISC valve 17. Specifically, the ECU 10 is programmed to execute the control processing of FIG. 2 every 8 milliseconds to attain the automatic engine start and stop operation.

The ECU 10 first determines at step 101 whether the engine is prohibited from being automatically stopped. Automatic engine stop is prohibited when the automatic start and stop operation is prohibited by a manual switch, or abnormality of sensors is detected. If the determination result is YES indicating that the automatic engine stop is prohibited, this control processing is immediately finished. If the determination result is NO indicating that the automatic engine stop is not prohibited, the ECU 10 determines at step 102 whether the predetermined automatic engine stop condition is satisfied. The automatic engine stop condition is satisfied and an automatic engine stop flag is turned on, as shown in FIG. 3, when

(1) the engine speed sensor 14 detects that the engine speed is lower than a predetermined engine speed,

(2) the neutral switch 28 detects that the manual transmission is geared to the neutral position,

(3) the coolant temperature sensor 19 detects that the coolant temperature is sufficiently raised, and

(4) the vehicle speed sensor 13 detects that the vehicle speed is lower than a predetermined vehicle speed (5 km/hr).

If the determination result at step 102 is NO, the ECU 10 further determines at step 103 whether the refuel switch 18 detects the refueling of the fuel tank. The refuel switch 18 is turned on (refueling flag is turned on) when the fuel tank inlet is open, and turned off when it is closed.

The refueling operation may alternatively detected based on increasing changes in the fuel level in the fuel tank per time, or based on decreasing changes in the pressure in the fuel tank. Further the refueling operation may be detected based on decreasing changed in the evaporated fuel gas pressure in the evaporated gas purge system which connects the fuel tank and the intake system of the engine through a canister, because the gas pressure in the purge system decreases if the fuel tank inlet is opened for refueling.

If the determination result at step 102 or 103 is YES, the ECU 10 automatically stops the engine by stopping the operations of the igniter 11 and the injector 12.

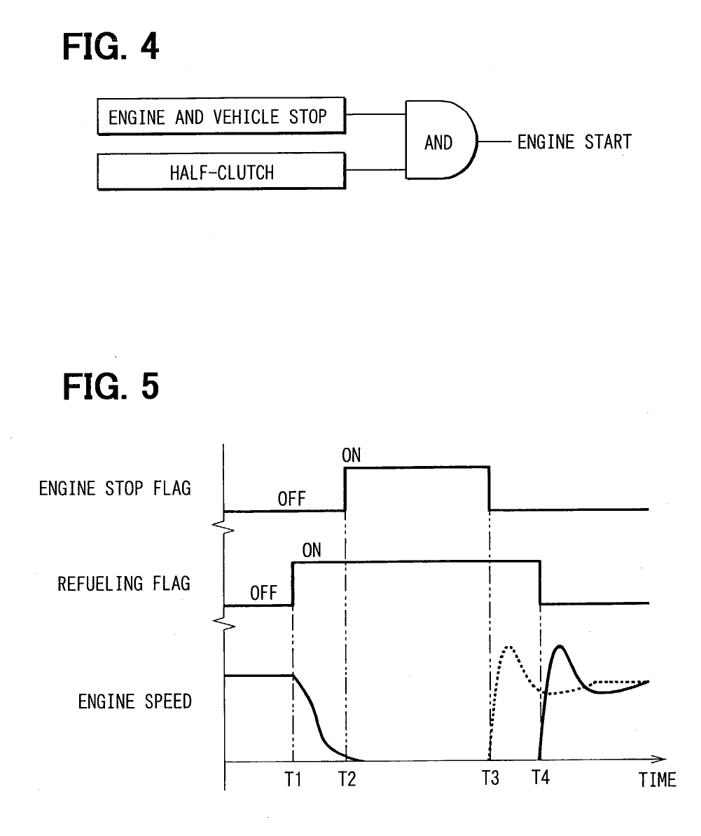

After stopping the engine at step 104 or determining at step 103 that the fuel tank is not being refueled (NO), the ECU 10 determines at step 105 whether a predetermined automatic engine start condition is satisfied. The automatic engine start condition is satisfied and the automatic engine stop flag is turned off, as shown in FIG. 4, when

(1) the vehicle speed sensor 13 and the engine speed sensor 14 detect that the vehicle and the engine are at rest, and

(2) the half-clutch sensor 20 detects that the clutch is pressed a little.

If the determination result at step 105 is YES, the ECU 10 further determines at step 106 whether the refuel switch 18 detects the refueling operation. If the determination result at step 106 is NO indicating that the fuel tank is not being refueled, the ECU 10 automatically starts the engine at step 107 by driving the igniter 11, injector 12, starter 16 and the like. After the engine start rotating, the starter operation is stopped. The ECU 10 however does not automatically start the engine, if the determination result at step 105 is NO or the determination result at step 106 is YES indicating that the fuel tank is being refueled, the control processing is terminated thereby prohibiting the automatic engine starting operation after the automatic engine stopping operation.

The operation of the embodiment is graphically shown in FIG. 5 assuming that the refueling is attained from time T1 to T4. Specifically, when the refueling starts at time T1, the fuel supply and ignition are shut off to automatically stop the engine and the engine speed falls quickly as shown by the solid line in FIG. 5, even if the automatic engine stop flag is not turned on. When the engine becomes at rest, the engine stop flag is turned on to indicate that the automatic engine stop condition (1) to (4) is satisfied.

When the automatic engine stop flag is turned off at time T3 because of pressing of the clutch for instance, if the refueling operation is not taken into consideration, the engine is automatically started as shown with the dotted line in FIG. 5 even when the refueling is continuing. However, according to this embodiment, the engine is not automatically started until the refueling is finished at time T4. Therefore, the engine rotation speed rises from time T4 as shown with the solid line.

The present invention should not be limited to the disclosed embodiment, but may be modified in many other ways. For instance, driver's pressing of an accelerator may be taken into a condition of the automatic engine starting (FIG. 4) in addition to or in place of the driver's pressing of the clutch. Further, turning-on of an electric load may be taken into a condition of the automatic engine starting.

What is claimed is:

1. An automatic engine start and stop system for vehicles comprising:
automatic stop means for automatically stopping an engine when a predetermined automatic stop condition is satisfied;
automatic start means for automatically starting the engine when a predetermined automatic start condition is satisfied;
refueling detecting means for detecting refueling of a fuel tank; and
prohibition means for prohibiting an automatic engine starting operation of the automatic start means irrespective of the automatic start condition when the refueling of the fuel tank is detected by the refueling detecting means.

2. The automatic engine start and stop system as in claim 1, wherein the refueling detecting means detects the refueling of the fuel tank in response to an opening of an inlet of the fuel tank.

3. The automatic engine start and stop system as in claim 1, wherein the refueling detecting means detects increasing changes in fuel level in the fuel tank.

4. The automatic engine start and stop system as in claim 1, wherein the refueling detecting means detects changes in pressure in the fuel tank.
